(19) United States
(12) Patent Application Publication
(10) Pub. No.: US 2017/0178630 A1
(43) Pub. Date: Jun. 22, 2017

(54) SENDING A TRANSCRIPT OF A VOICE CONVERSATION DURING TELECOMMUNICATION

(71) Applicant: QUALCOMM Incorporated, San Diego, CA (US)

(72) Inventors: Bapineedu Chowdary GUMMADI, Hyderabad (IN); Binil Francis JOSEPH, Hyderabad (IN); Rajesh NARUKULA, Hyderabad (IN); Venkata A Naidu BABBADI, Hyderabad (IN)

(21) Appl. No.: 14/975,144

(22) Filed: Dec. 18, 2015

(51) Int. Cl. G10L 15/26; H04M 3/42

(52) U.S. Cl. CPC G10L 15/26; H04M 3/42382

(57) ABSTRACT

Disclosed are methods and systems for sending a transcript of a voice conversation during telecommunication. In an aspect, a first user device participating in a voice call with at least a second user device, receives voice data from a user of the first user device, converts the voice data from the user of the first user device into a speech-to-text transcript of the voice data, transmits the voice data to the second user device on a first channel, and transmits the speech-to-text transcript of the voice data to the second user device on a second channel.

Aspects of this disclosure relate generally to telecommunications, and more particularly to sending a transcript of a voice conversation during telecommunication and the like.

Wireless communication devices are used in many different environments, and it is sometimes difficult for listeners to understand the words of the speaker. For example, in the case of poor wireless communication channel conditions, congested networking, high interference, etc., voice packets (e.g., in a Voice-Over-IP (VoIP) call) are often lost and it becomes difficult for the listener(s) to understand what the speaker is saying. As another example, in the case of mismatching environments, such as where the speaker is in a silent environment but the listener(s) are in a noisy environment, the listener(s) might not be able to perceive the conversation correctly. As yet another example, the listener(s) may experience difficulty in understanding the speaker because of the speaker's accent.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

A method for sending a transcript of a voice conversation during telecommunication includes receiving, at a first user device participating in a voice call with at least a second user device, voice data from a user of the first user device, converting, by the first user device, the voice data from the user of the first user device into a speech-to-text transcript of the voice data, transmitting, by the first user device, the voice data to the second user device on a first channel, and transmitting, by the first user device, the speech-to-text transcript of the voice data to the second user device on a second channel.

An apparatus for sending a transcript of a voice conversation during telecommunication includes at least one transceiver of a first user device configured to receive voice data from a user of the first user device, the first user device participating in a voice call with at least a second user device, and at least one processor of the first user device configured to convert the voice data from the user of the first user device into a speech-to-text transcript of the voice data, wherein the at least one transceiver is further configured to transmit the voice data to the second user device on a first channel, and to transmit the speech-to-text transcript of the voice data to the second user device on a second channel.

An apparatus for sending a transcript of a voice conversation during telecommunication includes means for receiving, at a first user device participating in a voice call with at least a second user device, voice data from a user of the first user device, means for converting, by the first user device, the voice data from the user of the first user device into a speech-to-text transcript of the voice data, means for transmitting, by the first user device, the voice data to the second user device on a first channel, and means for transmitting, by the first user device, the speech-to-text transcript of the voice data to the second user device on a second channel.

A non-transitory computer-readable medium for sending a transcript of a voice conversation during telecommunication at least one instruction to receive, at a first user device participating in a voice call with at least a second user device, voice data from a user of the first user device, at least one instruction to convert, by the first user device, the voice data from the user of the first user device into a speech-to-text transcript of the voice data, at least one instruction to transmit, by the first user device, the voice data to the second user device on a first channel, and at least one instruction to transmit, by the first user device, the speech-to-text transcript of the voice data to the second user device on a second channel.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of embodiments of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1 illustrates a high-level system architecture of a wireless communications system in accordance with an embodiment of the disclosure.

FIG. 2 illustrates examples of user equipment (UEs) in accordance with embodiments of the disclosure.

FIG. 3 illustrates a communication device that includes structural components to perform the functionality disclosed herein.

FIG. 4A illustrates a high-level diagram of exemplary communications between a source user device and a destination user device according to at least one aspect of the disclosure.

FIG. 4B illustrates the source user device and the destination user device of FIG. 4A in greater detail.

FIG. 5 illustrates an exemplary flow for sending a transcript of a voice conversation during telecommunication according to at least one aspect of the disclosure.

FIG. 6 illustrates an exemplary flow for sending a transcript of a voice conversation during telecommunication.

FIG. 7 is a simplified block diagram of several sample aspects of an apparatus configured to support communication as taught herein.

### DETAILED DESCRIPTION

Disclosed herein are methods and systems for sending a transcript of a voice conversation during telecommunication. In an aspect, a first user device participating in a voice call with at least a second user device receives voice data from a user of the first user device, converts the voice data from the user of the first user device into a speech-to-text transcript of the voice data, transmits the voice data to the second user device on a first channel, and transmits the speech-to-text transcript of the voice data to the second user device on a second channel.

These and other aspects of the disclosure are disclosed in the following description and related drawings directed to specific embodiments of the disclosure. Alternate embodiments may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the disclosure” does not require that all embodiments of the disclosure include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A client device, referred to herein as a user equipment (UE), may be mobile or stationary, and may communicate with a radio access network (RAN). As used herein, the term “UE” may be referred to interchangeably as an “access terminal” or “AT,” a “wireless device,” a “subscriber device,” a “subscriber terminal,” a “subscriber station,” a “user terminal” or UT, a “mobile terminal,” a “mobile station,” a “user device,” and variations thereof. Generally, UEs can communicate with a core network via the RAN, and through the core network the UEs can be connected with external networks such as the Internet. Of course, other mechanisms of connecting to the core network and/or the Internet are also possible for the UEs, such as over wired access networks, WiFi networks (e.g., based on IEEE 802.11, etc.) and so on. UEs can be embodied by any of a number of types of devices including but not limited to PC cards, compact flash devices, external or internal modems, wireless or wireline phones, and so on. A communication link through which UEs can send signals to the RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

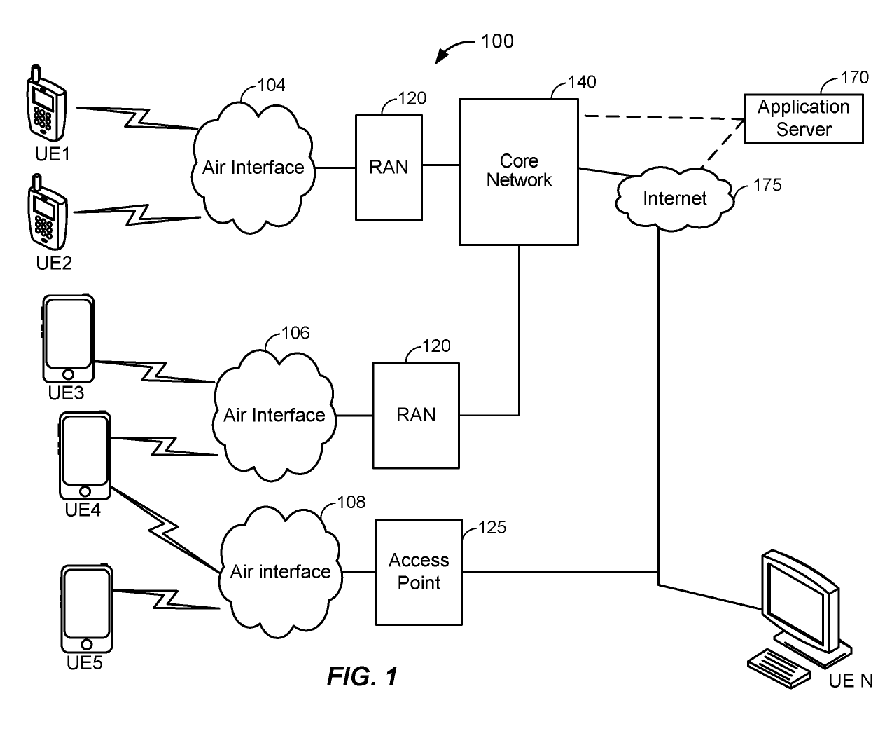

FIG. 1 illustrates a high-level system architecture of a wireless communications system 100 in accordance with an embodiment of the disclosure. The wireless communications system 100 contains UEs 1 . . . N. The UEs 1 . . . N can include cellular telephones, personal digital assistant (PDAs), pagers, a laptop computer, a desktop computer, and so on. For example, in FIG. 1, UEs 1 . . . 2 are illustrated as cellular calling phones, UEs 3 . . . 5 are illustrated as cellular touchscreen phones or smart phones, and UE N is illustrated as a desktop computer or PC.

Referring to FIG. 1, UEs 1 . . . N are configured to communicate with an access network (e.g., the RAN 120, an access point 125, etc.) over a physical communications interface or layer, shown in FIG. 1 as air interfaces 104, 106, 108 and/or a direct wired connection. The air interfaces 104 and 106 can comply with a given cellular communications protocol (e.g., CDMA (Code Division Multiple Access), EVDO (Evolution-Data Optimized), eHRPD (Evolved High Rate Packet Data), GSM (Global System for Mobile Communications), EDGE (Enhanced Data Rates for GSM Evolution), W-CDMA (Wideband CDMA), LTE (Long-Term Evolution), etc.), while the air interface 108 can comply with a wireless IP protocol (e.g., IEEE 802.11).

The RAN 120 includes a plurality of access points that serve UEs over air interfaces, such as the air interfaces 104 and 106. The access points in the RAN 120 can be referred to as “access nodes” or “ANs,” “access points” or “APs,” “base stations” or “BSs,” “Node Bs,” “eNode Bs,” and so on. These access points can be terrestrial access points (or ground stations), or satellite access points. The RAN 120 is configured to connect to a core network 140 that can perform a variety of functions, including bridging circuit switched (CS) calls between UEs served by the RAN 120 and other UEs served by the RAN 120 or a different RAN altogether, and can also mediate an exchange of packet-switched (PS) data with external networks such as Internet 175. The Internet 175 includes a number of routing agents and processing agents (not shown in FIG. 1 for the sake of convenience). In FIG. 1, UE N is shown as connecting to the Internet 175 directly (i.e., separate from the core network 140, such as over an Ethernet connection of WiFi or 802.11-based network). The Internet 175 can thereby function to bridge packet-switched data communications between the UE N and the UEs 1 . . . N via the core network 140.

Also shown in FIG. 1 is the access point 125 that is separate from the RAN 120. The access point 125 may be connected to the Internet 175 independent of the core network 140 (e.g., via an optical communication system such as FiOS, a cable modem, etc.). The air interface 108 may serve UE 4 or UE 5 over a local wireless connection, such as IEEE 802.11 in an example. The UE N is shown as a desktop computer with a wired connection to the Internet 175, such as a direct connection to a modem or router, which can correspond to the access point 125 itself in an example (e.g., for a WiFi router with both wired and wireless connectivity).

Referring to FIG. 1, an application server 170 is shown as connected to the Internet 175, the core network 140, or both. The application server 170 can be implemented as a plurality of structurally separate servers, or alternately may correspond to a single server. As will be described below in more detail, the application server 170 is configured to support one or more communication services (e.g., Voice-over-Internet Protocol (VoIP) sessions, Push-to-Talk (PTT) sessions, group communication sessions, social networking services, etc.) for UEs that can connect to the application server 170 via the core network 140 and/or the Internet 175, and/or to provide content (e.g., web page downloads) to the UEs.

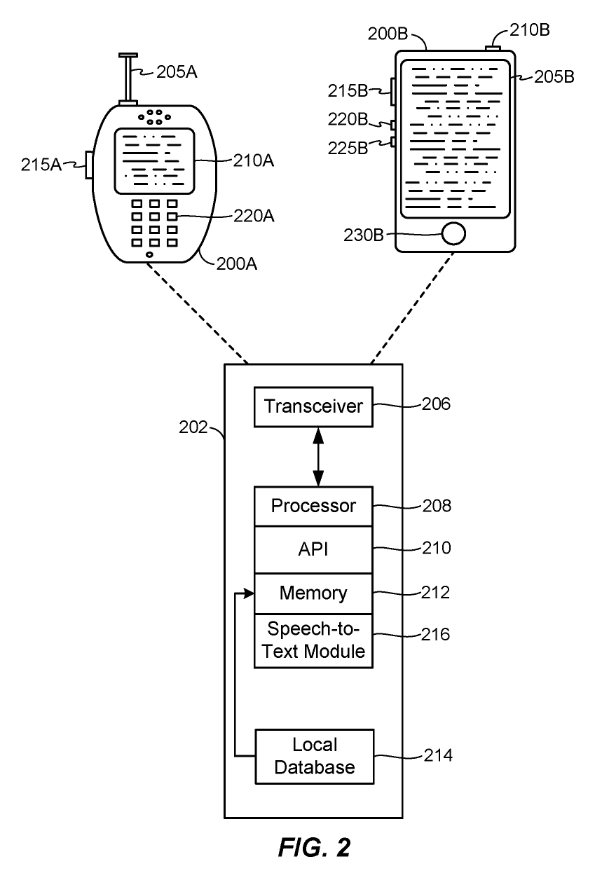

FIG. 2 illustrates examples of UEs (e.g., client devices) in accordance with embodiments of the disclosure. Referring to FIG. 2, UE 200A is illustrated as a calling telephone and UE 200B is illustrated as a touchscreen device (e.g., a smart phone, a tablet computer, etc.). As shown in FIG. 2, an external casing of UE 200A is configured with an antenna 205A, a display 210A, at least one button 215A (e.g., a PTT button, a power button, a volume control button, etc.) and a keypad 220A among other components, as is known in the art. Also, an external casing of UE 200B is configured with a touchscreen display 205B, peripheral buttons 210B, 215B, 220B and 225B (e.g., a power control button, a volume or vibrate control button, an airplane mode toggle button, etc.), and at least one front-panel button 230B (e.g., a Home button, etc.), among other components, as is known in the art. While not shown explicitly as part of the UE 200B, the UE 200B can include one or more external antennas and/or one or more integrated antennas that are built into the external casing of the UE 200B, including but not limited to WiFi antennas, cellular antennas, satellite position system (SPS) antennas (e.g., global positioning system (GPS) antennas), and so on.

While internal components of UEs such as the UEs 200A and 200B can be embodied with different hardware configurations, a basic high-level UE configuration for internal hardware components is shown as a platform 202 in FIG. 2. The platform 202 can receive and execute software applications, data and/or commands transmitted from the RAN 120 that may ultimately come from the core network 140, the Internet 175 and/or other remote servers and networks (e.g., application server 170, web URLs, etc.). The platform 202 can also independently execute locally stored applications without RAN interaction. The platform 202 can include a transceiver 206 operably coupled to at least one processor 208, such as an application specific integrated circuit (ASIC), microprocessor, logic circuit, or other data processing device. The processor 208 executes an application programming interface (API) 210 layer that interfaces with any resident programs in a memory 212 of the UEs 200A and 200B. The memory 212 can be comprised of read-only or random-access memory (RAM and ROM), EEPROM, flash cards, or any memory common to computer platforms. The platform 202 also can include a local database 214 that can store applications not actively used in the memory 212, as well as other data. The local database 214 is typically a flash memory cell, but can be any secondary storage device as known in the art, such as magnetic media, EEPROM, optical media, tape, soft or hard disk, or the like. The platform 202 may also include a speech-to-text module 216 for converting voice data of a user of the UEs 200A and 200B into text. The speech-to-text module 216 may be a hardware component coupled to or incorporated into the processor 208, a software module stored in the memory 212 and executable by the processor 208, or a combination of hardware and software (e.g., firmware).

Accordingly, an embodiment of the disclosure can include a UE (e.g., UEs 200A, 200B, etc.) including the ability to perform the functions described herein. As will be appreciated by those skilled in the art, the various logic elements can be embodied in discrete elements, software modules executed on a processor or any combination of software and hardware to achieve the functionality disclosed herein. For example, the processor 208, memory 212, API 210 and the local database 214 may all be used cooperatively to load, store and execute the various functions disclosed herein and thus the logic to perform these functions may be distributed over various elements. Alternatively, the functionality could be incorporated into one discrete component. Therefore, the features of the UEs 200A and 200B in FIG. 2 are to be considered merely illustrative and the disclosure is not limited to the illustrated features or arrangement.

The wireless communication between the UEs 200A and/or 200B and the RAN 120 can be based on different technologies, such as CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the UEs 200A and 200B from the RAN 120 using a variety of networks and configurations. Accordingly, the illustrations provided herein are not intended to limit the embodiments of the disclosure and are merely to aid in the description of aspects of embodiments of the disclosure.

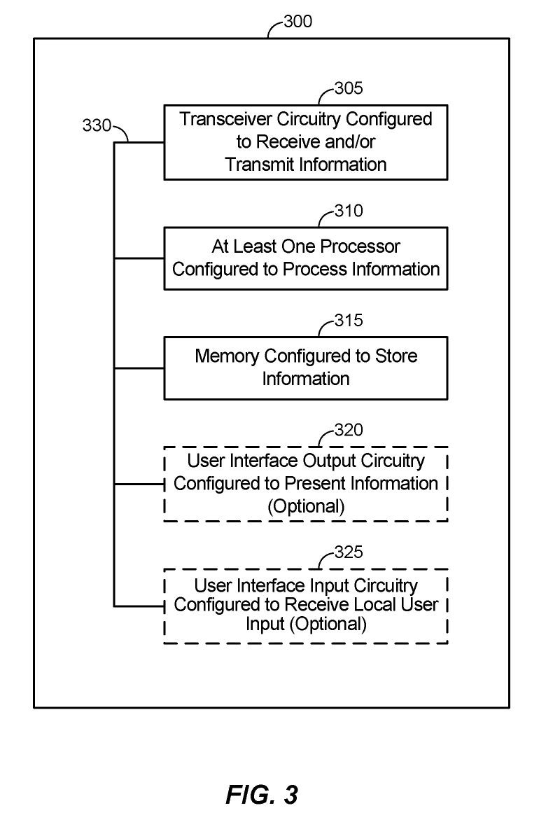

FIG. 3 illustrates a communication device 300 that includes structural components to perform functionality. The communication device 300 can correspond to any of the above-noted communication devices, including but not limited to UEs 200A or 200B, any component of the RAN 120, any component of the core network 140, any components coupled with the core network 140 and/or the Internet 175 (e.g., the application server 170), and so on. Thus, the communication device 300 can correspond to any electronic device that is configured to communicate with (or facilitate communication with) one or more other entities over the wireless communications system 100 of FIG. 1.

Referring to FIG. 3, the communication device 300 includes transceiver circuitry configured to receive and/or transmit information 305. In an example, if the communication device 300 corresponds to a wireless communications device (e.g., UE 200A and/or UE 200B, RAN 120, access point 125, etc.), the transceiver circuitry configured to receive and/or transmit information 305 can include a wireless communications interface (e.g., 2G, CDMA, W-CDMA, 3G, 4G, LTE, Bluetooth, Wi-Fi, Wi-Fi Direct, LTE Direct, etc.) such as a wireless transceiver and associated hardware (e.g., an RF antenna, a MODEM, a modulator and/or demodulator, etc.). In another example, the transceiver circuitry configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application server 170) or components of the core network 140, the transceiver circuitry configured to receive and/or transmit information 305 can correspond to an Ethernet card, in an example, that connects the network-based server to other communication entities via an Ethernet protocol. In a further example, the transceiver circuitry configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The transceiver circuitry configured to receive and/or transmit information 305 can also include software that, when executed, permits the associated hardware of the transceiver circuitry configured to receive and/or transmit information 305 to perform its reception and/or transmission function(s). However, the transceiver circuitry configured to receive and/or transmit information 305 does not correspond to software alone, and the transceiver circuitry configured to receive and/or transmit information 305 relies at least in part upon structural hardware to achieve its functionality.

Referring to FIG. 3, the communication device 300 further includes at least one processor configured to process information 310. Example implementations of the type of processing that can be performed by the at least one processor configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the at least one processor configured to process information 310 can include a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the at least one processor configured to process information 310 may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The at least one processor configured to process information 310 can also include software that, when executed, permits the associated hardware of the at least one processor configured to process information 310 to perform its processing function(s). However, the at least one processor configured to process information 310 does not correspond to software alone, and the at least one processor configured to process information 310 relies at least in part upon structural hardware to achieve its functionality.

Referring to FIG. 3, the communication device 300 further includes memory configured to store information 315. In an example, the memory configured to store information 315 can include at least a non-transitory memory and associated hardware (e.g., a memory controller, etc.). For example, the non-transitory memory included in the memory configured to store information 315 can correspond to RAM, flash memory, read-only memory (ROM), erasable programmable ROM (EPROM), electrically erasable programmable ROM (EEPROM), registers, hard disk, a removable disk, a CD-ROM, or any other form of storage medium known in the art. The memory configured to store information 315 can also include software that, when executed, permits the associated hardware of the memory configured to store information 315 to perform its storage function(s). However, the memory configured to store information 315 does not correspond to software alone, and the memory configured to store information 315 relies at least in part upon structural hardware to achieve its functionality.

Referring to FIG. 3, the communication device 300 further optionally includes user interface output circuitry configured to present information 320. In an example, the user interface output circuitry configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the UE 200A and/or the UE 200B as shown in FIG. 2, the user interface output circuitry configured to present information 320 can include the display 210A and/or the touchscreen display 205B. In a further example, the user interface output circuitry configured to present information 320 can be omitted for certain communication devices, such as network communication devices that do not have a local user (e.g., network switches or routers, remote servers, etc.). The user interface output circuitry configured to present information 320 can also include software that, when executed, permits the associated hardware of the user interface output circuitry configured to present information 320 to perform its presentation function(s). However, the user interface output circuitry configured to present information 320 does not correspond to software alone, and the user interface output circuitry configured to present information 320 relies at least in part upon structural hardware to achieve its functionality.

Referring to FIG. 3, the communication device 300 further optionally includes user interface input circuitry configured to receive local user input 325. In an example, the user interface input circuitry configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the UE 200A and/or the UE 200B as shown in FIG. 2, the user interface input circuitry configured to receive local user input 325 can include buttons 215A and 215B-230B, the keypad 220A, the touchscreen display 205B, etc. In a further example, the user interface input circuitry configured to receive local user input 325 can be omitted for certain communication devices, such as network communication devices that do not have a local user (e.g., network switches or routers, remote servers, etc.). The user interface input circuitry configured to receive local user input 325 can also include software that, when executed, permits the associated hardware of the user interface input circuitry configured to receive local user input 325 to perform its input reception function(s). However, the user interface input circuitry configured to receive local user input 325 does not correspond to software alone, and the user interface input circuitry configured to receive local user input 325 relies at least in part upon structural hardware to achieve its functionality.

Referring to FIG. 3, while the configured structural components of 305 through 325 are shown as separate or distinct blocks, in FIG. 3, that are coupled to each other via an associated communication bus 330, it will be appreciated that the hardware and/or software by which the respective configured structural components of 305 through 325 performs their respective functionality can overlap in part. For example, any software used to facilitate the functionality of the configured structural components of 305 through 325 can be stored in the non-transitory memory associated with the memory configured to store information 315, such that the configured structural components of 305 through 325 each performs their respective functionality (i.e., in this case, software execution) based in part upon the operation of software stored by the memory configured to store information 315. Likewise, hardware that is directly associated with one of the configured structural components of 305 through 325 can be borrowed or used by other configured structural components of 305 through 325 from time to time. For example, the at least one processor configured to process information 310 can format data into an appropriate format before being transmitted by the transceiver circuitry configured to receive and/or transmit information 305, such that the transceiver circuitry configured to receive and/or transmit information 305 performs its functionality (i.e., in this case, transmission of data) based in part upon the operation of structural hardware associated with the at least one processor configured to process information 310.

Accordingly, the various structural components of 305 through 325 are intended to invoke an aspect that is at least partially implemented with structural hardware, and are not intended to map to software-only implementations that are independent of hardware and/or to non-structural functional interpretations. Other interactions or cooperation between the structural components of 305 through 325 will become clear to one of ordinary skill in the art from a review of the aspects described below in more detail.

There are situations where it would be beneficial for the listener(s) on a voice call (whether a group call or a call between only two users) to be able to see a real-time speech-to-text transcript of the words that the speaker is saying. For example, in the case of poor wireless communication channel conditions, congested networking, high interference, etc., voice packets (e.g., in a Voice-Over-IP (VoIP) call) are often lost and it becomes difficult for the listener(s) to understand what the speaker is saying. As another example, in the case of mismatching environments, such as where the speaker is in a silent environment but the listener(s) are in a noisy environment, the listener(s) might not be able to perceive the conversation correctly. As yet another example, the listener(s) may experience difficulty in understanding the speaker because of the speaker's accent.

Present speech-to-text systems convert the words of the speaker to text at the user device(s) of the listener(s). In contrast, the present disclosure provides for generating a speech-to-text transcript of the speaker's words at the speaker's user device and sending it to the listener(s). This provides a number of advantages. For example, converting from speech to text at the source will provide better conversion accuracy, since the speaker's user device has access to the raw voice packets, whereas at the listener's user device, the speaker's voice will have codec artifacts as well as other distortions added by the wireless channel. As another example, the speaker's user device will generally be trained with the speaker's voice, and thus the speech-to-text accuracy will be much higher. This will also be beneficial where the speaker has an accent that is difficult for the listener(s) to understand.

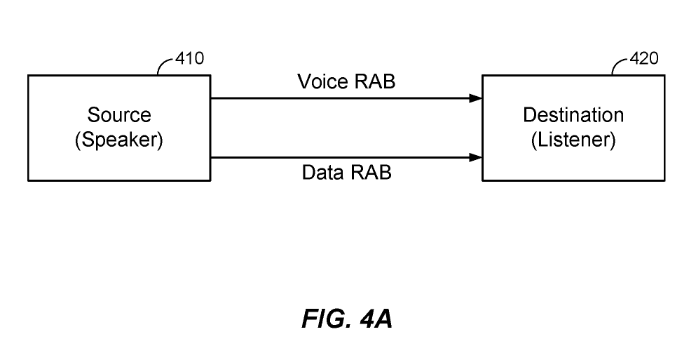

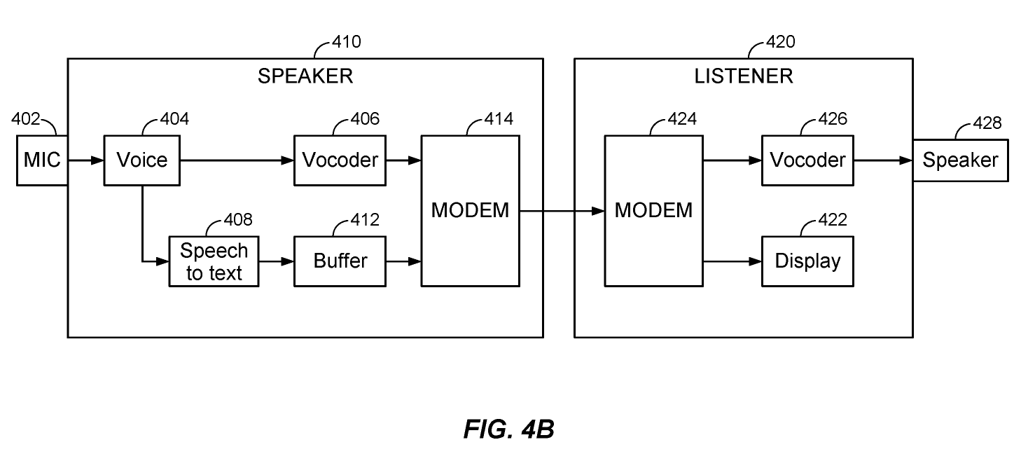

FIG. 4A illustrates a high-level diagram of exemplary communications between a source user device 410 (i.e., the speaker) and a destination user device 420 (i.e., a listener) according to at least one aspect of the disclosure. As shown in FIG. 4, the mechanism of the present disclosure sends speech and text over different radio access bearers (RABs), or channels. The speech-to-text transcript generated at the source user device 410 is sent more reliably than the corresponding speech. For example, the transcript may be sent over a data RAB using, for example, an instant messaging application layer protocol, which can be based on Session Initiation Protocol (SIP) or Extensible Messaging and Presence Protocol (XMPP). In contrast, the voice information may be sent over a circuit switched (CS) network or a packet switched (PS) network, which may be less reliable (e.g., lower reliability on a voice PS connection is expected, as the end-to-end delay is the prime concern in voice communication, not reliability). Thus, even if speech packets are lost due to poor communication channel conditions, the transcript has a higher probability of successfully reaching the destination user device 420 where it can be read by the user.

FIG. 4B illustrates the source user device 410 and the destination user device 420 of FIG. 4A in greater detail. As shown in FIG. 4B, the source user device 410 includes a microphone 402 that generates voice data 404, a vocoder 406 that encodes the voice data 404, a speech-to-text module 408 that converts the voice data 404 to text, and a buffer 412 that buffers the speech-to-text data generated by the speech-to-text module 408. A modem 414 receives the encoded voice data from the vocoder 406 and the speech-to-text data from the buffer 412 and transmits them on different RABs to the destination user device 420. The buffer 412 may be implemented as a circular buffer, whereby text that has been transmitted is replaced by text that has not yet been transmitted. Note that the source user device 410 can be implemented without the buffer 412, as some application layer protocols provide the buffers as a part of the retransmission mechanism.

At the destination user device 420, a modem 424 receives the encoded voice data on the voice RAB and the speech-to-text data on the data RAB. The modem 424 sends the encoded voice data to a vocoder 426 to be decoded and reproduced by a speaker 428, and sends the speech-to-text data to a display 422 to be displayed to the user. As will be appreciated, where two or more user devices are participating in a voice call, a user device may at times be the source user device 410 and at other times the destination user device 420 depending on whether the user device is sending voice and speech-to-text data at the time or is receiving voice and speech-to-text data.

With reference to FIG. 2, where the source user device 410 corresponds to either the UE 200A and/or the UE 200B, the modem 414 may be coupled to the transceiver 206, and the speech-to-text module 408 may correspond to the speech-to-text module 216. With further reference to FIG. 2, where the destination user device 420 corresponds to either the UE 200A and/or the UE 200B, the modem 424 may be coupled to the transceiver 206 and the display 422 may correspond to the display 210A or the touchscreen display 205B.

With reference to FIG. 3, where the source user device 410 corresponds to the communication device 300, the microphone 402 may correspond to the user interface input circuitry configured to receive local user input 325, the modem 414 may be coupled to the transceiver circuitry configured to receive and/or transmit information 305, and the speech-to-text module 408 may be a hardware component integrated into or coupled to the at least one processor configured to process information 310. With further reference to FIG. 3, where the destination user device 420 corresponds to the communication device 300, the modem 424 may be coupled to the transceiver circuitry configured to receive and/or transmit information 305 and the display 422 may correspond to the user interface output circuitry configured to present information 320.

The destination user device 420 can display the speech-to-text transcript as it is received, similar to a scrolling subtitle that the user can view during the phone conversation. In order to view the transcript while still listening to the call, the user may view the text on the display 422 and listen to the call using speaker mode or a hands-free device, such as a Bluetooth earphone. Alternatively, the user may view the transcript on another smart device, such as a smart watch, while holding the destination user device 420 to his or her ear.

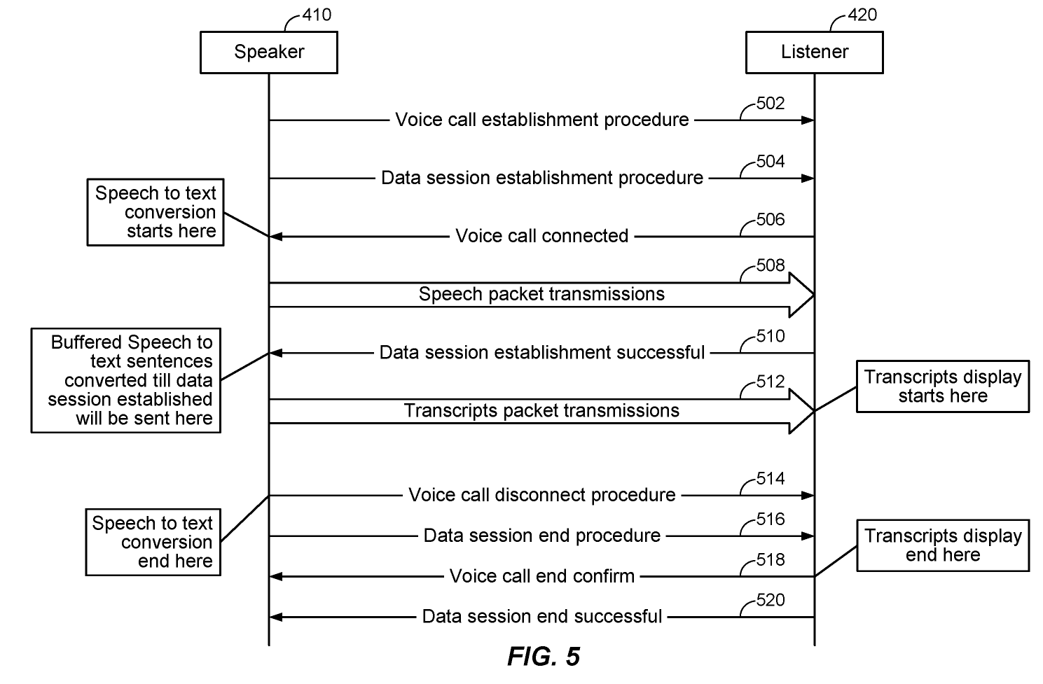

FIG. 5 illustrates an exemplary flow for sending a transcript of a voice conversation during telecommunication according to at least one aspect of the disclosure. At 502, the source user device 410 initiates a voice call establishment procedure with the destination user device 420. At 504, the source user device 410 initiates a data session establishment procedure with the destination user device 420. As will be appreciated, while only one destination user device 420 is illustrated in FIG. 5, there may be more than one destination user device, such as in the case of a group call.

At 506, the voice call is connected and the user of the source user device 410 can begin speaking. When the user begins speaking, the source user device 410, for example, the speech-to-text module 408, begins the speech-to-text conversion of the user's speech and stores the text in the buffer 412 until the data session is established or fails to be established. Note that the speech-to-text conversion will stop if the data session fails at any point in time, which may occur, for example, if the destination user device 420 does not support the speech-to-text display feature. Although not illustrated in FIG. 5, the source user device 410 may send the speech-to-text transcript automatically or in response to a request from the destination user device 420.

At 508, the source user device 410, for example, the modem 414 and/or the transceiver 206, begins sending speech packets to the destination user device 420.

At 510, the data session is established. The data session can be established using, for example, any existing instant messaging application layer protocols, which, as noted above, may be based on, for example, SIP or XMPP. The transport layer protocol used should ensure in-order delivery of the data packets (e.g., Transmission Control Protocol (TCP)). The Quality of Service (QoS) of the data session should ensure tolerable latency (e.g., latency below a given threshold) for transcript delivery to ensure less delay between conversations. Note that the voice call establishment procedure at 502 and 506 and the subsequent voice conversation will go on regardless of whether or not the data session establishment at 504 and 510 was successful.

At 512, once the data session is established, any text in the buffer 412 can now be sent to the destination user device 420. Once the text is received, the destination user device 420 can begin displaying a transcript of the speaker's speech. For the duration of the voice call, or until the failure of the data session, the source user device 410 will send subsequent speech transcripts in real-time at the end of each word or sentence spoken by the user of the source user device 410.

The destination user device 420 can display the speech-to-text transcripts using a closed captioning method, whereby newer transcripts replace older transcripts. Alternatively, the destination user device 420 can use a scrolling method, whereby new transcripts are added to the display of older transcripts, and when there is too much text to view on the screen of the destination user device 420, a scroll bar is displayed so that the display of the transcripts can be scrolled to show earlier transcripts. This scrolling display method mitigates the effects of the varying delay of the transcripts with respect to the corresponding speech. More specifically, there will be a delay between the time when the user of the destination user device 420 hears the words of the speaker and the time that the destination user device 420 receives and displays the corresponding speech-to-text transcript of the speaker's words. The scrolling method allows the user of the destination user device 420 to scroll through the transcript of the speaker's speech.

At 514, the source user device 410 initiates a voice call disconnect procedure. At this point, the voice conversation ends and the source user device 410 stops the speech-to-text conversion of the speech of the user of the source user device 410. At 516, the source user device 410 initiates a data session termination procedure. At 518, the destination user device 420 confirms the disconnection of the voice call. At this point, the destination user device 420 can stop displaying the transcript of the speaker's words. At 520, the destination user device 420 confirms the termination of the data session.

As will be appreciated, the user device corresponding to the source user device 410 may at times act as the source user device 410 and at other times as the destination user device 420, depending on whether the user device is sending voice and speech-to-text data at the time or is receiving voice and speech-to-text data. Similarly, the one or more user devices corresponding to the destination user device 420 may at times act as the source user device 410 and at other times as the destination user device 420, depending on whether the one or more user devices are sending voice and speech-to-text data at the time or are receiving voice and speech-to-text data

As will be appreciated, the operations illustrated in FIG. 5 need not occur in the illustrated order. For example, the voice call and the data session may be established simultaneously or in reverse order. Similarly, the voice call and the data session may be terminated simultaneously or in reverse order.

Although not illustrated in FIG. 5, the destination user device 420 can save the speech-to-text transcripts for future reference.

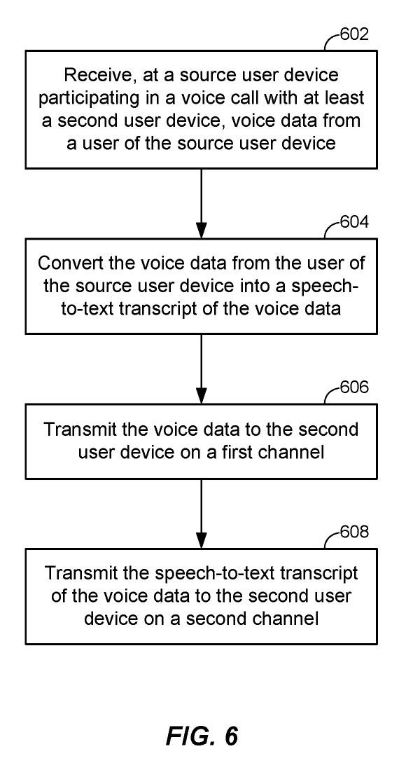

FIG. 6 illustrates an exemplary flow for sending a transcript of a voice conversation during telecommunication. The flow illustrated in FIG. 6 may be performed by the source user device 410. The source user device 410 may be participating in a voice call with at least one second user device, such as the destination user device 420.

At 602, in the source user device 410, for example, the microphone 402 or the vocoder 406, receives voice data from a user of the source user device 410.

At 604, in the source user device 410, for example, the speech-to-text module 408, converts the voice data from the user of the first user device into a speech-to-text transcript of the voice data.

At 606, in the source user device 410, for example, the modem 414 and/or the transceiver 206, transmits the voice data to the second user device on a first channel.

At 608, in the source user device 410, for example, the modem 414 and/or the transceiver 206, transmits the speech-to-text transcript of the voice data to the second user device on a second channel. The first channel and the second channel may be different channels, such as different RABs, as discussed above. For example, the first channel may be a voice channel and the second channel may be a data channel.

Although not illustrated in FIG. 6, the flow may further include establishing, by the source user device 410, a voice call on the first channel for sending the voice data to the second user device, such as at 502 and 506 of FIG. 5, and establishing a data session on the second channel for sending the speech-to-text transcript to the second user device, such as at 504 and 510 of FIG. 5. The establishment of the voice call is independent of the establishment of the data session.

Further, although not illustrated in FIG. 6, the flow may further include buffering, in the buffer 412, the speech-to-text transcript of the voice data until the data session is established on the second channel.

In an embodiment, although not illustrated in FIG. 6, the flow may further include receiving a request from the second user device to transmit the speech-to-text transcript of the voice data to the second user device. In an alternative embodiment, however, the source user device 410 may transmit the speech-to-text transcript of the voice data to the second user device on the second channel without receiving a request from the second user device to transmit the speech-to-text transcript.

Further still, although not illustrated, the flow illustrated in FIG. 6 may further include ceasing transmission of the speech-to-text transcript of the voice data to the second user device before an end of transmission of the voice data to the second user device. The first user device may cease transmission of the speech-to-text transcript of the voice data to the second user device based on reception of a request from the second user device to cease the transmission of the speech-to-text transcript of the voice data to the second user device. Alternatively, the first user device may cease transmission of the speech-to-text transcript of the voice data to the second user device based on reception of an instruction from a user of the first user device to cease the transmission of the speech-to-text transcript of the voice data to the second user device.

As discussed above, the second user device may display the speech-to-text transcript on a user interface of the second user device. The speech-to-text transcript may scroll on the user interface of the second user device as the second user device receives the voice data. The user interface of the second user device may be configured to receive input to scroll to an earlier portion of the speech-to-text transcript.

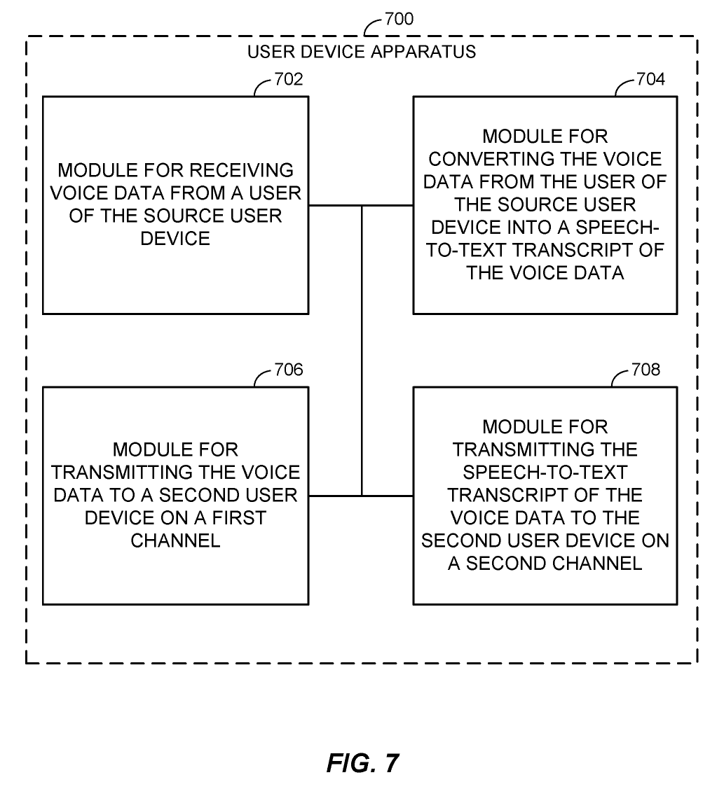

FIG. 7 illustrates an example base station apparatus 700 represented as a series of interrelated functional modules. A module for receiving 702 may correspond at least in some aspects to, for example, a communication device, such as transceiver 206 in FIG. 2, transceiver circuitry configured to receive and/or transmit information 305 in FIG. 3, and/or modem 414 in FIG. 4B, as discussed herein. A module for converting 704 may correspond at least in some aspects to, for example, a processing system, such as processor 208 in FIG. 2, the at least one processor configured to process information 310 in FIG. 3, and/or speech-to-text module 408 in FIG. 4B, as discussed herein. A module for transmitting 706 may correspond at least in some aspects to, for example, a communication device, such as transceiver 206 in FIG. 2, transceiver circuitry configured to receive and/or transmit information 305 in FIG. 3, and/or modem 414 in FIG. 4B, as discussed herein. A module for transmitting 708 may correspond at least in some aspects to, for example, a communication device, such as transceiver 206 in FIG. 2, transceiver circuitry configured to receive and/or transmit information 305 in FIG. 3, and/or modem 414 in FIG. 4B, as discussed herein.

The functionality of the modules of FIG. 7 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 7, as well as other components and functions described herein, may be implemented using any suitable means. Such means also may be implemented, at least in part, using corresponding structure as taught herein. For example, the components described above in conjunction with the “module for” components of FIG. 7 also may correspond to similarly designated “means for” functionality. Thus, in some aspects one or more of such means may be implemented using one or more of processor components, integrated circuits, or other suitable structure as taught herein.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing shows illustrative embodiments of the disclosure, it should be noted that various changes and modifications could be made herein without departing from the scope of the disclosure as defined by the appended claims. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated.

A complete listing of the claims, including current amendments (if any), is as follows:

1. A method for sending a transcript of a voice conversation during telecommunication, comprising:
receiving, at a first user device participating in a voice call with at least a second user device, voice data from a user of the first user device;
converting, by the first user device, the voice data from the user of the first user device into a speech-to-text transcript of the voice data;
transmitting, by the first user device, the voice data to the second user device on a first channel; and
transmitting, by the first user device, the speech-to-text transcript of the voice data to the second user device on a second channel.

2. The method of claim 1, wherein the first channel and the second channel are different channels.

3. The method of claim 1, wherein the first channel comprises a voice channel and the second channel comprises a data channel.

4. The method of claim 1, further comprising:
establishing a voice call on the first channel for sending the voice data to the second user device; and
establishing a data session on the second channel for sending the speech-to-text transcript to the second user device.

5. The method of claim 4, further comprising:
buffering the speech-to-text transcript of the voice data at the first user device until the data session is established on the second channel.

6. The method of claim 4, wherein the data session uses an instant messaging application layer protocol.

7. The method of claim 4, wherein the establishment of the voice call is independent of the establishment of the data session.

8. The method of claim 4, wherein a Quality of Service (QoS) of the data session provides tolerable latency for transcript delivery.

9. The method of claim 1, further comprising:
receiving a request from the second user device to transmit the speech-to-text transcript of the voice data to the second user device.

10. The method of claim 1, wherein the first user device transmits the speech-to-text transcript of the voice data to the second user device on the second channel without receiving a request from the second user device to transmit the speech-to-text transcript.

11. The method of claim 1, further comprising:
ceasing transmission of the speech-to-text transcript of the voice data to the second user device before an end of transmission of the voice data to the second user device.

12. The method of claim 11, wherein the first user device ceases transmission of the speech-to-text transcript of the voice data to the second user device based on reception of a request from the second user device to cease the transmission of the speech-to-text transcript of the voice data to the second user device.

13. The method of claim 11, wherein the first user device ceases transmission of the speech-to-text transcript of the voice data to the second user device based on reception of an instruction from a user of the first user device to cease the transmission of the speech-to-text transcript of the voice data to the second user device.

14. The method of claim 1, wherein the speech-to-text transcript is displayed on a user interface of the second user device.

15. The method of claim 14, wherein the speech-to-text transcript scrolls on the user interface of the second user device as the second user device receives the voice data.

16. The method of claim 15, wherein the user interface of the second user device is configured to receive input to scroll to an earlier portion of the speech-to-text transcript.

17. An apparatus for sending a transcript of a voice conversation during telecommunication, comprising:
at least one transceiver of a first user device configured to receive voice data from a user of the first user device, the first user device participating in a voice call with at least a second user device; and
at least one processor of the first user device configured to convert the voice data from the user of the first user device into a speech-to-text transcript of the voice data,
wherein the at least one transceiver is further configured to transmit the voice data to the second user device on a first channel, and to transmit the speech-to-text transcript of the voice data to the second user device on a second channel.

18. The apparatus of claim 17, wherein the first channel comprises a voice channel and the second channel comprises a data channel.

19. The apparatus of claim 17, wherein the at least one transceiver is further configured to:
establish a voice call on the first channel for sending the voice data to the second user device; and
establish a data session on the second channel for sending the speech-to-text transcript to the second user device.

20. The apparatus of claim 19, wherein the data session uses an instant messaging application layer protocol.

21. The apparatus of claim 19, wherein establishment of the voice call is independent of establishment of the data session.

22. The apparatus of claim 17, wherein the at least one transceiver is further configured to receive a request from the second user device to transmit the speech-to-text transcript of the voice data to the second user device.

23. The apparatus of claim 17, wherein the at least one transceiver transmits the speech-to-text transcript of the voice data to the second user device on the second channel without receiving a request from the second user device to transmit the speech-to-text transcript.

24. The apparatus of claim 17, wherein the at least one transceiver is further configured to cease transmission of the speech-to-text transcript of the voice data to the second user device before an end of transmission of the voice data to the second user device.

25. The apparatus of claim 24, wherein the at least one transceiver ceases transmission of the speech-to-text transcript of the voice data to the second user device based on reception of a request from the second user device to cease the transmission of the speech-to-text transcript of the voice data to the second user device.

26. The apparatus of claim 24, wherein the at least one transceiver ceases transmission of the speech-to-text transcript of the voice data to the second user device based on reception of an instruction from a user of the first user device to cease the transmission of the speech-to-text transcript of the voice data to the second user device.

27. The apparatus of claim 17, wherein the speech-to-text transcript is displayed on a user interface of the second user device.

28. The apparatus of claim 27, wherein the speech-to-text transcript scrolls on the user interface of the second user device as the second user device receives the voice data.

29. An apparatus for sending a transcript of a voice conversation during telecommunication, comprising:
means for receiving, at a first user device participating in a voice call with at least a second user device, voice data from a user of the first user device;
means for converting, by the first user device, the voice data from the user of the first user device into a speech-to-text transcript of the voice data;
means for transmitting, by the first user device, the voice data to the second user device on a first channel; and
means for transmitting, by the first user device, the speech-to-text transcript of the voice data to the second user device on a second channel.

30. A non-transitory computer-readable medium for sending a transcript of a voice conversation during telecommunication, comprising:
at least one instruction to receive, at a first user device participating in a voice call with at least a second user device, voice data from a user of the first user device;
at least one instruction to convert, by the first user device, the voice data from the user of the first user device into a speech-to-text transcript of the voice data;
at least one instruction to transmit, by the first user device, the voice data to the second user device on a first channel; and
at least one instruction to transmit, by the first user device, the speech-to-text transcript of the voice data to the second user device on a second channel.
